(19) United States
(12) Patent Application Publication
(10) Pub. No.: US 2019/0130464 A1
(43) Pub. Date: May 2, 2019

(54) IDENTIFYING SERVICE PROVIDERS BASED ON RFP REQUIREMENTS

(71) Applicant: Microsoft Technology Licensing, LLC, Redmond, WA (US)

(72) Inventors: Hong Yao, Fremont, CA (US); Yi Zhang, Sunnyvale, CA (US); Yu Liu, Sunnyvale, CA (US); Onkar A. Dalal, Santa Clara, CA (US); Thogori C. Karago, San Francisco, CA (US); Ajita Thomas, Sunnyvale, CA (US)

(73) Assignee: Microsoft Technology Licensing, LLC, Redmond, WA (US)

(21) Appl. No.: 15/799,496

(22) Filed: Oct. 31, 2017

(51) Int. Cl. G06Q 30/06; G06F 7/02

(52) U.S. Cl. CPC G06Q 30/0611; G06F 7/026

(57) ABSTRACT

The disclosed embodiments provide a system for processing data. During operation, the system identifies a set of providers that meet a set of requirements in a request for proposal (RFP) from a consumer based on an overall compatibility between the set of requirements and the set of providers. Next, the system generates a ranking of the set of providers based on the compatibility and a network distance between the consumer and the set of providers in a social network. The system then selects one or more providers from the ranking as matches for the RFP. Finally, the system transmits the RFP to the one or more providers.

### BACKGROUND

### Field

The disclosed embodiments relate to techniques for performing model-based identification of service providers based on requests for proposal.

### Related Art

Online networks may include nodes representing entities such as individuals and/or organizations, along with links between pairs of nodes that represent different types and/or levels of social familiarity between the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, an online professional network may connect providers with consumers. The consumers may submit requests for proposal (RFPs) for services or products, and providers may respond to the RFPs with proposals that address the consumers' requirements. However, a RFP submitted by a consumer cannot be provided to all providers because the consumer will be inundated with hundreds of proposals. Navigating through all of the proposals will be overwhelming and will lead to an unpleasant experience. Further, since the providers do not all provide the same types of services, a provider should not receive a RFP unless the provider can appropriately respond to the RFP. Hence, when a system receives a RFP from a consumer, the system needs to quickly determine which providers are to receive the RFP so that consumer can receive proposals in a timely manner.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of identifying service providers that meet requirements in an RFP from a consumer in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

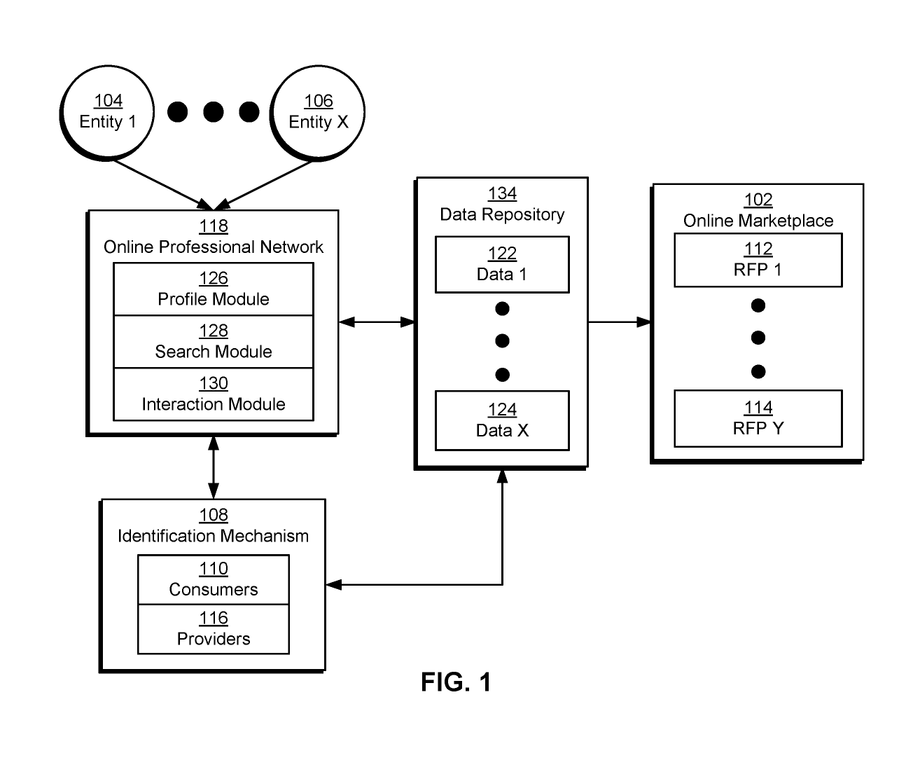

The disclosed embodiments provide a method, apparatus, and system for using social network data to identify service providers that match requirements in requests for proposal (RFPs) and/or consumers that have generated the RFPs. As shown in FIG. 1, consumers 110 and providers 116 may be members of a social network, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

The entities may also use an interaction module 130 to interact with other entities on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 may be used by an online marketplace 102 associated with and/or provided by online professional network 118 to improve interaction between consumers 110 and providers 116 and/or use of online marketplace 102 by consumers 110 and providers 116. Online marketplace 102 may allow consumers 110 to generate RFPs (e.g., RFP 1 112, RFP y 114) for products or services by inputting requirements associated with the RFPs into a user interface, form, email, and/or other mechanism for digital communication or interaction. Online marketplace 102 may use the inputted requirements to select providers 116 that meet the requirements and transmit the RFPs to the selected providers 116. The selected providers 116 may respond to the RFPs with proposals, and consumers 110 that generated the RFPs may use the proposals to select providers 116 for the corresponding products or services.

As shown in FIG. 1, consumers 110 and/or providers 116 may be identified by an identification mechanism 108 using data from data repository 134 and/or online professional network 118. First, identification mechanism 108 may identify consumers 110 based on browsing, searching, and/or viewing activities of entities with online professional network 118. For example, identification mechanism 108 may determine that a member of online professional network 118 is interested in career services offered through online marketplace 102 based on the member's job-seeking activity (e.g., job searches, job applications, etc.) and/or profile-editing activity (e.g., profile edits, soliciting recommendations or endorsements, etc.) with online professional network 118. In another example, identification mechanism 108 may identify a member of online professional network 108 as a potential consumer when the member searches online marketplace 102 for products and/or services and/or submits an RFP through online marketplace 102.

Second, identification mechanism 108 may identify providers 116 as members of online professional network 118 who are highly skilled at services offered through online marketplace 102 and/or who have registered with online marketplace 102 as providers 116 of the services. For example, identification mechanism 108 may use endorsements, recommendations, and/or other social validation of skills listed in the member's profiles with online professional network 118 to identify members who are likely to be highly capable of providing services listed in online marketplace 102. In another example, identification mechanism 108 may identify a member of online professional network 118 as a provider in online marketplace 102 when the member views a page in online marketplace 102 for a service that strongly matches the member's skills and/or registers as a provider with online marketplace 102.

In one or more embodiments, online marketplace 102 uses online professional network 118 data to match providers 116 of products and/or services to consumers 110 looking for the products and/or services. As described in further detail below, online marketplace 102 may use profile and/or activity data with online professional network 118 to determine individual compatibilities between providers 116 and requirements in each RFP from a consumer, and aggregate the individual compatibilities into an assessment of overall compatibility between providers 116 and the RFP. Online marketplace 102 may rank providers 116 by the overall compatibilities, network and/or geographic distances between providers 116 and the consumer, previous performance or behavior of providers 116 in online marketplace 102, and/or other attributes. Online marketplace 102 may then use the ranking to select one or more providers 116 as matches for the RFP and transmit the RFP to the selected providers 116. Consequently, online marketplace 102 may identify providers 116 who are highly qualified in providing the requested services and/or supplying the requested products, are geographically or socially close to the consumer, and/or have good historic performance within online marketplace 102.

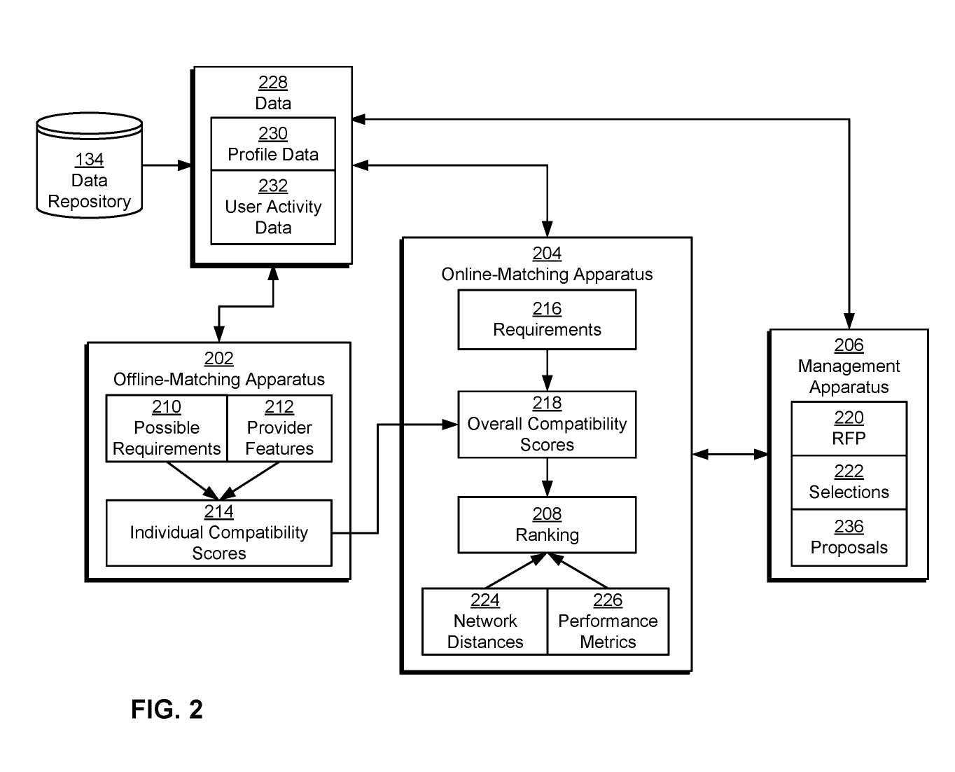

FIG. 2 shows a system for processing data in accordance with the disclosed embodiments. More specifically, FIG. 2 shows a system for matching consumers and providers in an online marketplace, such as online marketplace 102 of FIG. 1. More specifically, a management apparatus 206 in the system includes functionality to obtain, from a consumer, an RFP 220 containing a set of requirements 216 for providing a service or product. Management apparatus 206 also outputs selections 222 of providers that match RFP 220 and receives proposals 236 in response to RFP 220 from the providers. In turn, the consumer may use proposals 236 and/or qualifications of the providers to select a provider of the product or service specified in RFP 220 and conduct business with the provider.

As shown in FIG. 2, the system utilizes data 228 from data repository 134, which includes profile data 230 for members of a social network or other community of users (e.g., online professional network 118 of FIG. 1), as well as user activity data 232 that tracks the members' activity within and/or outside the social network. Profile data 230 may include data associated with member profiles in the social network. For example, profile data 230 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, publications) attributes. Profile data 230 may also include a set of groups to which the user belongs, the user's contacts and/or connections, patents or publications associated with the user, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 230 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 232 may include records of member interactions with one another and/or content associated with the social network. For example, user activity data 232 may be used to track impressions, clicks, likes, dislikes, shares, hides, comments, posts, updates, conversions, and/or other user interaction with content in the social network. User activity data 232 may also, or instead, track other types of social network activity, including connections, messages, and/or interaction with groups or events. User activity data 232 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes.

User activity data 232 may additionally reflect activities related to the online marketplace, such as browsing or searching the online marketplace for providers, services, products, and/or projects; submitting, receiving, responding to, accepting, and/or declining RFPs (e.g., RFP 220) and proposals; and/or rating or reviewing providers and/or consumers. Like profile data 230, user activity data 232 may be used to create a graph, with nodes in the graph representing social network members and/or content and edges between pairs of nodes indicating actions taken by members, such as creating or sharing articles or posts, sending messages, sending or accepting connection requests, sending and accepting RFPs, sending and accepting proposals, joining groups, and/or following other entities.

Profile data 230, user activity data 232, and/or other data in data repository 134 may be standardized before the data is used by components of the system. For example, skills in profile data 230 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

An offline-matching apparatus 202 uses a set of provider features 212 from data 228 and a set of possible requirements 210 for RFP 220 to calculate a set of individual compatibility scores 214 between possible requirements 210 and providers in the online marketplace. For example, offline-matching apparatus 202 may use batch processing to periodically generate and/or update individual compatibility scores 214 for all providers in the online marketplace using the latest possible requirements 210 and/or provider features 212.

Provider features 212 used to calculate individual compatibility scores 214 may include profile features, social validation features, geographic features, and/or activity features. The profile features may be obtained from profile data for each provider. For example, the profile features may include the title, industry, language, summary, occupation, work experience (e.g., number of current and/or past positions, length of employment, etc.), skills, seniority, employer, employer size, groups, contact information, profile visibility, profile completeness, and/or other profile attributes of each provider's profile with the social network. The profile features may also include the provider's number of connections in the social network, group memberships in the social network, publications or patents associated with the provider, certifications or licenses listed with the social network, and/or other attributes related to the provider's professional use of the social network. Because the provider is likely to be connected to other social network members with similar attributes, the provider features may also be supplemented with member attributes of the provider's connections, such as skills, companies, schools, and/or industries of the connections.

Social validation features for each provider may include metrics related to endorsements, recommendations, ratings, reviews, collaborations, discussions, articles, posts, comments, shares, and/or other member-to-member interactions that are relevant to skills, work experience, titles, industries, and/or other profile features of the provider. For example, the social validation features may include the number of endorsements, number of recommendations, number of articles published, and/or number of profile views of the provider's social network profile.

Geographic features may describe the location of each provider. For example, the geographic features may include geographic coordinates (e.g., latitude and longitude), a postal code, a region, and/or a pre-calculated distance between the provider and another location (e.g., a location of a potential consumer).

Activity features for each provider may describe the provider's type or level of activity with the social network and/or online marketplace. For example, the activity features may include an activity level of the provider with the social network and/or online marketplace, which may be binary (e.g., dormant or active) or calculated by aggregating different types of activities into an overall activity count and/or a bucketized activity score. In another example, the activity features may include attributes (e.g., activity frequency, dormancy, etc.) related to specific types of social network activity, such as messaging activity (e.g., sending messages within the social network), publishing activity (e.g., publishing posts or articles in the social network), mobile activity (e.g., accessing the social network through a mobile device), and/or email activity (e.g., accessing the social network through email or email notifications). In a third example, the activity features may include performance metrics 226 related to the provider's use of the online marketplace, such as metrics that characterize the provider's historical performance with respect to RFPs (e.g., number and/or rate of RFPs received, ignored, passed on, responded to, opened, etc.) and/or subsequent proposals from the provider (e.g., number and/or rate of proposals sent, viewed, responded to, accepted, declined, flagged, and/or withdrawn).

After provider features 212 are obtained from data repository 134, offline-matching apparatus 202 and/or another component of the system may modify some or all of the features. First, the component may apply imputations that add default values, such as zero numeric values or median values, to features with missing values. Second, the component may “bucketize” numeric values for some features (e.g., number of employees) into ranges of values and/or a smaller set of possible values. Third, the component may apply, to one or more subsets of features, a log transformation that reduces skew in numeric values and/or a binary transformation that converts zero and positive numeric values to respective Boolean values of zero and one. Fourth, the component may normalize scores to be within a range (e.g., between 0 and 10), verify that feature ratios are within the range of 0 and 1, and perform other transformations of the features. In general, such preprocessing and/or modification of features may be performed and/or adapted based on configuration files and/or a central feature list.

Offline-matching apparatus 202 also obtains and/or generates a set of possible requirements 210 for a given RFP (e.g., RFP 220). Possible requirements 210 may include possible values and/or ranges of parameters used to define and/or create the RFP. For example, each RFP may include a first requirement for a service to be provided, such as a service related to graphic design, digital marketing, copywriting, software development, information technology (IT), career services, accounting, financial services, real estate, insurance, home improvement videography, photography, translation, technical writing, law, wellness, and/or event planning Based on the identified service, the RFP may identify a second requirement for a project type (e.g., game, utility application, mobile commerce application, business application, social application, smartwatch application, mobile application, web application, and/or native application for software development). The RFP may also include a location of the consumer, such as a city, state, postal code, and/or street address at which the consumer resides or works, as well as a parameter indicating the extent to which geographic proximity to the consumer is required (e.g., mandatory, desired, optional). The RFP may further specify one or more required skills (e.g., Java, object-oriented programming, C++ for software development), tools (e.g., integrated development environments (IDEs), application-programming interfaces (APIs), revision control tools, testing tools, and/or platforms used in software development), and/or tasks (e.g., implementing a user interface, business logic layer, and/or backend for an application) for performing the service. As a result, possible requirements for the RFP may include all services, project types, locations, skills, tools, platforms, timelines, costs, and/or tasks that can be specified within the RFP.

Offline-matching apparatus 202 may additionally select and/or use possible requirements 210 based on relevance to provider features 212. For example, offline-matching apparatus 202 may include, in possible requirements 210, values and/or parameters that can be matched to skills, work experience, education, titles, summaries, and/or other provider features 212. The values and/or parameters may be explicitly selected as options in RFP 220, extracted from freeform text in RFP 220 and/or descriptions of the corresponding possible requirements 210, and/or inferred from the context and/or content of RFP 220. Conversely, offline-matching apparatus 202 may omit, from possible requirements 210, requirements that cannot be matched to known provider features 212, such as requirements related to project timeline, budget, and/or scope.

Offline-matching apparatus 202 then calculates individual compatibility scores 214 using each requirement in possible requirements 210 and a set of provider features 212 for each provider. Each individual compatibility score may represent the similarity of a provider to a requirement in possible requirements 210 and/or the extent to which the provider is able to meet the requirement. For example, offline-matching apparatus 202 may filter the providers to include only the providers that have registered to provide a given service. Next, for each additional possible requirement associated with the service, offline-matching apparatus 202 may use a clustering technique, unsupervised learning technique, similarity function, classification technique, regression technique, and/or other technique to calculate an individual similarity score between the requirement and provider features 212 for each provider in the filtered set of providers.

In other words, offline-matching apparatus 202 may generate, for each provider registered to provide a service specified in RFP 220, a set of individual compatibility scores 214 representing the provider's compatibility with all possible requirements associated with an RFP (e.g., RFP 220) related to the service. Offline-matching apparatus 202 may store individual compatibility scores 214 in data repository 134 and/or another repository for subsequent retrieval and use. For example, offline-matching apparatus 202 may generate an index from individual compatibility scores 214 for all providers in the online marketplace. Each entry in the index may map an identifier for a specific requirement in possible requirements 210 to a set of providers and/or the providers' individual compatibility scores 214 for the requirement. Prior to including the individual compatibility scores in the index, one or more thresholds may be applied to the individual compatibility scores to ensure that providers included in the index meet a minimum compatibility with each requirement.

Next, an online-matching apparatus 204 includes functionality to use individual compatibility scores 214 from offline-matching apparatus 202 and a set of requirements 216 from RFP 220 to generate a set of overall compatibility scores 218 for the providers. Each overall compatibility score may represent the overall compatibility of a provider with all requirements 216 in RFP 220. As a result, the overall compatibility score may be produced by aggregating individual compatibility scores 214 between the provider and requirements 216.

For example, online-matching apparatus 204 may receive RFP 220 from management apparatus 206 after RFP 220 is filled out and submitted by a consumer in the online marketplace. Online-matching apparatus 204 may match the service identifier specified in and/or associated with RFP 220 to identify a set of providers that are registered to provide the corresponding service. Next, online-matching apparatus 204 may use an index of individual compatibility scores 214 to retrieve a subset of individual compatibility scores 214 between the providers and individual requirements 216 listed in RFP 220. Online-matching apparatus 204 may then use a weighted combination of individual compatibility scores 214 for each provider to produce an overall compatibility score 218 representing the provider's overall compatibility with RFP 220. Each weight used in the weighted combination may reflect the relative importance of the corresponding requirement in RFP 220. The importance may be specified by the consumer that created RFP 220 (e.g., a location requirement is given a high weight because the consumer requires in-person collaboration with a provider) and/or inherently associated with the requirement (e.g., a skill requirement is given a high weight because the corresponding skill is required to adequately provide the service).

After overall compatibility scores 218 are calculated, online-matching apparatus 204 creates a ranking 208 of the providers based on overall compatibility scores 218. For example, online-matching apparatus 204 may rank the providers in descending order of overall compatibility score, so that providers with the highest overall compatibility with RFP 220 are at the top of ranking 208 and providers with the lowest overall compatibility with RFP 220 are at the bottom of ranking 208.

Online-matching apparatus 204 may additionally update ranking 208 and/or overall compatibility scores 218 based on network distances 224, performance metrics 226, and/or other attributes associated with the providers. Network distances 224 may represent the social proximity of the consumer to the providers within the social network. For example, network distances 224 may identify the smallest number of members (i.e., number of hops) required to link the consumer and each provider within the social network, the types of relationships (e.g., employment, education, personal, follows, groups, etc.) linking the consumer and provider, and/or the strengths of the relationships (e.g., connection strength scores between members linking the consumer and provider). A provider's position in ranking 208 may be increased when the provider and consumer have a shorter network distance (e.g., when the provider is a first- and/or second-degree connection of the consumer) and/or decreased when the provider and consumer have a longer network distance (e.g., when the provider is more distant than a second-degree connection of the consumer).

Performance metrics 226 may track the historical behavior and/or performance of the providers with other RFPs, proposals, and/or consumers in the online marketplace. Like provider features 212, performance metrics 226 may include the number and/or rate of RFPs received, ignored, passed on, responded to, and/or opened by each provider. Performance metrics 226 may also, or instead, include the number and/or rate of each provider's proposals sent, viewed, responded to, accepted, declined, flagged, and/or withdrawn. As a result, a provider with a high rate of receipt, response, and/or acceptance for RFPs and/or proposals may be ranked higher than a provider with a lower rate of receipt, response, and/or acceptance for RFPs and/or proposals.

Finally, online-matching apparatus 204, management apparatus 206, and/or another component of the system generates selections 222 of one or more providers from ranking 208 as matches for RFP 220. For example, the component may select a highest-ranked subset of providers from ranking 208 for inclusion in selections 222. Selections 222 may thus include providers that are highly compatible with requirements 216 in RFP 220, geographically and/or socially close to the consumer, and/or associated with good historical performance in the online marketplace. The component may also, or instead, randomly select one or more providers from ranking 208 for inclusion in selections 222 to allow providers with little to no previous interaction within the online marketplace to connect with consumers, receive RFPs, and/or respond to RFPs with proposals.

After selections 222 are made, management apparatus 206 transmits RFP 220 to providers in selections 222 and receive proposals 236 from the providers in response to RFP 220. Management apparatus 206 and/or another component of the system may track the responses of the providers to RFP 220 and/or the subsequent response of the consumer to proposals 236 from the providers. In turn, the tracked behavior may be included as data 228 in data repository 134 for use in subsequent matching of providers to other RFPs. For example, the tracked behavior may be used to update provider features 212, performance metrics 226, and/or other attributes used to generate individual compatibility scores 214, overall compatibility scores 218, and/or ranking 208.

By matching providers to RFP 220 based on individual requirements 216 in RFP 220, socially validated skills and/or other provider features 212, social and/or geographic proximity to the consumer, and/or past performance of the providers, the system of FIG. 2 may leverage social network data to improve relevance and/or compatibility between the providers and RFP 220, verify the qualifications of the providers, and/or increase the use of social network connections in requesting or providing products or services through the online marketplace. Consequently, the system may improve technologies related to use of social networks and/or online marketplaces through network-enabled devices and/or applications, as well as user engagement, user experiences, and interaction through the social networks, online marketplaces, network-enabled devices, and/or applications.

Those skilled in the art will appreciate that the system of FIG. 2 may be implemented in a variety of ways. First, offline-matching apparatus 202, online-matching apparatus 204, management apparatus 206, and/or data repository 134 may be provided by a single physical machine, multiple computer systems, one or more virtual machines, a grid, one or more databases, one or more filesystems, and/or a cloud computing system. Offline-matching apparatus 202, online-matching apparatus 204, and management apparatus 206 may additionally be implemented together and/or separately by one or more hardware and/or software components and/or layers. The functionality of offline-matching apparatus 202, online-matching apparatus 204, and/or management apparatus 206 may additionally be configured or reconfigured for offline, online, and/or nearline execution.

Second, possible requirements 210, provider features 212, and/or other data used by offline-matching apparatus 202, online-matching apparatus 204, and/or management apparatus 206 may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history), profile completeness, social network interactions, and/or online marketplace activity.

Third, a number of techniques may be used to generate individual compatibility scores 214, overall compatibility scores 218, ranking 208, and/or other data used to match providers to RFP 220. For example, individual compatibility scores 214, overall compatibility scores 218, and/or ranking 208 may be calculated using artificial neural networks, Bayesian networks, naïve Bayes classifiers, support vector machines, clustering techniques, regression models, decision trees, random forests, hierarchical models, ensemble models, deep learning models, and/or other types of statistical models, statistical inference, or machine learning techniques.

Moreover, the same statistical model or separate statistical models may be used to generate scores and/or other output for various members, member segments, skills, services, and/or other types of attributes associated with providers, consumers, and/or RFPs in the online marketplace. For example, different statistical models and/or formulas may be used to calculate individual compatibility scores 214 and/or overall compatibility scores 218 for various services, RFPs, and/or providers. Alternatively, a single statistical model may be used to determine individual compatibility scores 214 and/or overall compatibility scores 218 for all services, RFPs, and/or providers in the online marketplace.

Finally, provider features 212, network distances 224, performance metrics 226, and/or other attributes used to generate selections 222 of providers as matches for RFP 220 may be used in different ways and/or at different times by offline-matching apparatus 202, online-matching apparatus 204, and/or other components of the system. For example, geographic features for each provider may be used to calculate individual compatibility scores 214 for all possible geographic locations of potential consumers in a given region and/or market segment. Alternatively, the geographic features may be used with network distances 224 and/or performance metrics 226 to change the positions of the providers in ranking 208 (e.g., by bumping up providers that are geographically closer to the consumer in ranking 208), remove providers from ranking 208 (e.g., providers that are farther than a threshold geographic distance from the consumer), and/or otherwise modify ranking 208 and/or selections 222. In another example, performance metrics 226 may be included in provider features 212 that are used to calculate individual compatibility scores and/or used after overall compatibility scores 218 are created to update ranking 208.

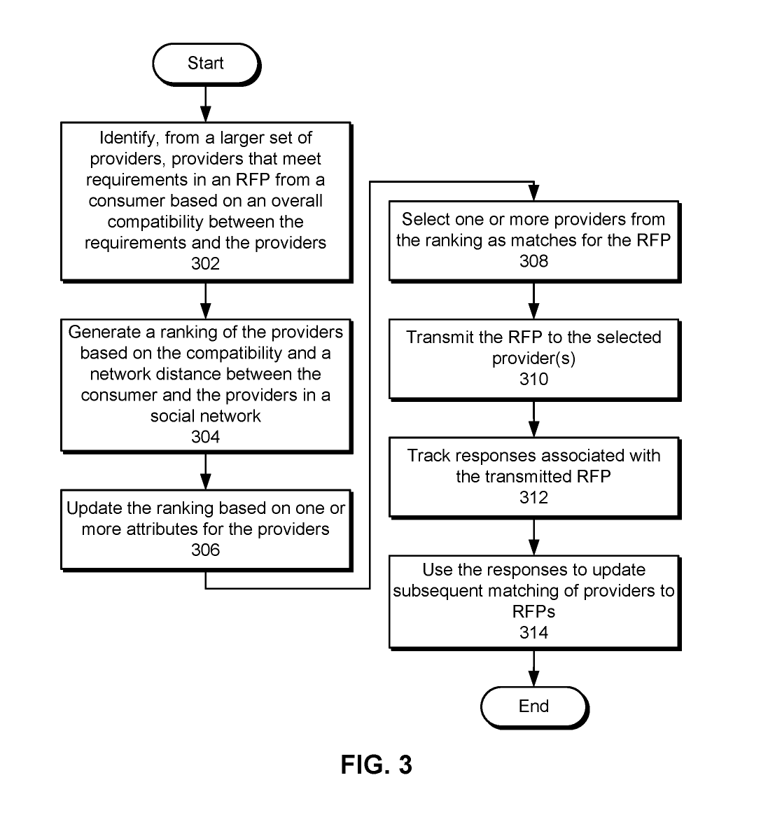

FIG. 3 shows a flowchart illustrating the processing of data in accordance with the disclosed embodiments. More specifically, FIG. 3 shows a flowchart of matching service providers to RFPs. In one or more embodiments, one or more of the steps may be omitted, repeated, and/or performed in a different order. Accordingly, the specific arrangement of steps shown in FIG. 3 should not be construed as limiting the scope of the embodiments.

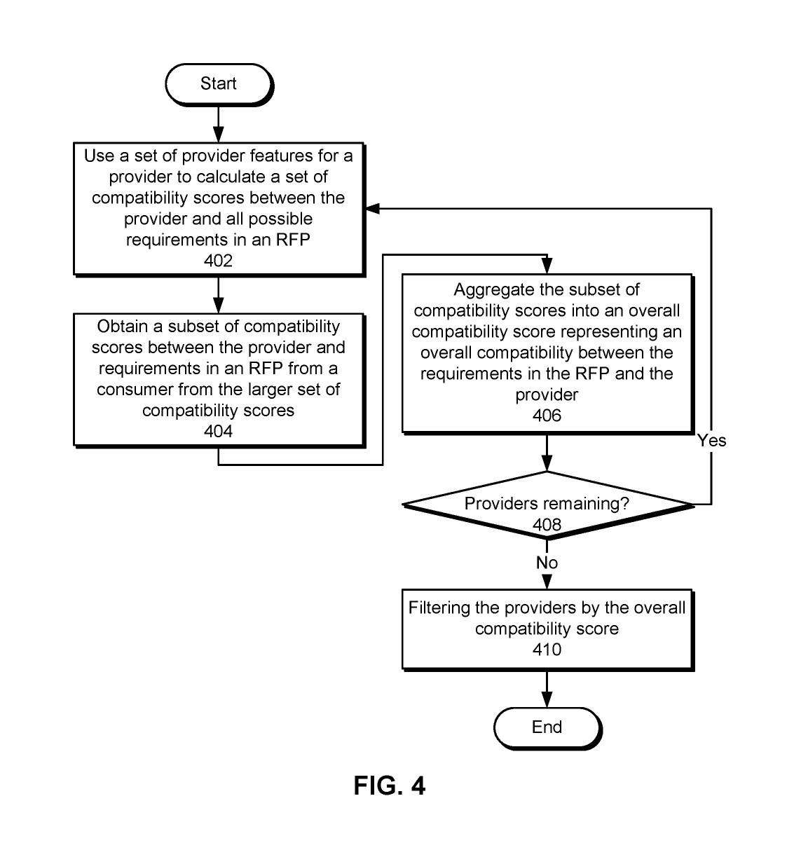

Initially, providers that meet requirements in an RFP from a consumer are identified from a larger set of providers based on an overall compatibility between the requirements and the providers (operation 302). The overall compatibility may be by calculating a set of compatibility scores between the providers and the requirements using features associated with the providers and/or requirements, as described in further detail below with respect to FIG. 4.

Next, a ranking of the providers is generated based on the compatibility and a network distance between the consumer and the providers in a social network (operation 304). For example, the providers may be ranked in descending order of overall compatibility with the RFP. Within the ranking, the position of a provider with a close network distance to the consumer (e.g., a first- or second-degree connection with the consumer) in a social network may be increased.

The ranking is also updated based on one or more attributes for the providers (operation 306). For example, the attributes may include performance metrics such as an RFP receipt metric (e.g., number or rate of RFPs received, opened, etc.), an RFP response metric (e.g., number or rate of RFP responses, ignores, declines, etc.), and/or a proposal response metric (e.g., number or rate of proposals sent, viewed, responded to, accepted, declined, flagged, and/or withdrawn). The performance metrics may also, or instead, include ratings, reviews, endorsements, recommendations, and/or other social reactions of other consumers to the providers. In turn, the performance metrics may be used to increase the positions of higher-performing providers in the ranking and decrease the positions of lower-performing providers in the ranking.

One or more providers are then selected from the ranking as matches for the RFP (operation 308), and the RFP is transmitted to the selected provider(s) (operation 310). For example, a pre-specified number of highest-ranked providers may be selected as the matches. An additional proportion (e.g., 20%) of providers in the ranking may also be included in the matches to give providers with little to no previous interaction with consumers and/or RFPs to respond to the RFP. After the matches are generated, the RFP may be provided to the selected providers through an online marketplace, messaging platform, social network, email, and/or other communication channel.

Responses associated with the transmitted RFP are also tracked (operation 312) and used to update subsequent matching of providers to RFPs (operation 314). For example, the responses may include responses of the providers to the RFP (e.g., views, responses, ignores, declines, replies, etc.) and/or the subsequent responses of the consumer and/or providers to proposals generated by the providers (e.g., proposals sent, viewed, responded to, accepted, declined, flagged, withdrawn, etc.). In turn, the responses may be used to update the performance metrics, provider features, and/or other data that is subsequently used to match the providers to other RFPs and/or consumers.

FIG. 4 shows a flowchart illustrating a process of identifying service providers that meet requirements in an RFP from a consumer in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a set of provider features for a provider is used to calculate a set of compatibility scores between the provider and all possible requirements in an RFP (operation 402). The provider features may include profile features (e.g., services, skills, headlines, summaries, positions, titles, and/or other profile data for the provider), social validation features (e.g., endorsements, recommendations, and/or other member-to-member interactions for validating the profile data), activity features (e.g., social network activity, online marketplace activity, etc.), and/or geographic features (e.g., coordinates, postal code, region, etc.) for the provider. To calculate the compatibility scores, a statistical model and/or formula may be used to identify a numeric similarity and/or compatibility between the provider features and one or more attributes (e.g., name, description, etc.) of each requirement.

Next, a subset of compatibility scores between the provider and requirements in an RFP from a consumer is obtained from the larger set of compatibility scores (operation 404). For example, each requirement specified in the RFP by the consumer may be matched to a unique identifier for the requirement, and the unique identifier may be used to retrieve the provider's compatibility score for the requirement from an index and/or other type of data store.

The subset of compatibility scores is then aggregated into an overall compatibility score representing the overall compatibility between the requirements in the RFP and the provider (operation 406). For example, individual compatibility scores between the provider and individual requirements in the RFP may be combined with a set of weights to produce the overall compatibility score. Each weight may represent the relative importance of the corresponding requirement within the RFP.

Operations 402-406 may be repeated for remaining providers (operation 408) associated with the RFP. For example, an overall compatibility score may be calculated for each provider that is registered to provide a product or service specified in the RFP. In addition, operation 402 may be performed using an offline- or batch-processing system, while operations 404-406 may be performed in an online basis (e.g., after the RFP is received from the consumer).

Finally, the providers are filtered by the overall compatibility score (operation 410). For example, a threshold may be applied to the overall compatibility score to ensure that the providers meet a minimum compatibility or qualification for responding to the RFP. In turn, the filtered providers may be ranked and/or further filtered to generate matches for the RFP, as discussed above.

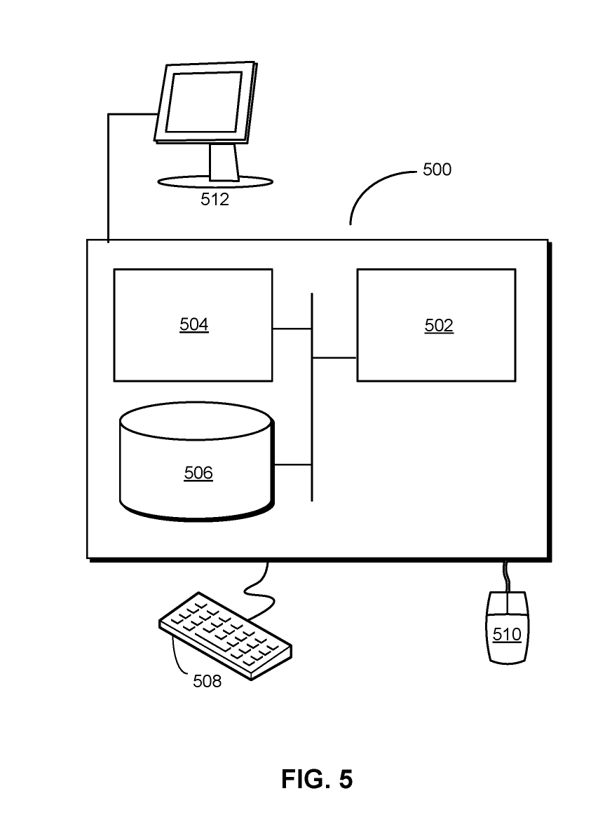

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an offline-matching apparatus, an online-matching apparatus, and/or a management apparatus, one or more of which may alternatively be termed or implemented as a module, mechanism, or other type of system component. The offline-matching apparatus and/or online-matching apparatus may identify a set of providers that meet a set of requirements in an RFP from a consumer based on an overall compatibility between the set of requirements and the providers. The matching apparatuses may also generate a ranking of the providers based on the compatibility and a network distance between the consumer and the providers in a social network and select one or more providers from the ranking as matches for the RFP. The management apparatus may then transmit the RFP to the selected provider(s).

In addition, one or more components of computer system 500 may be remotely located and connected to the other components over a network. Portions of the present embodiments (e.g., offline-matching apparatus, online-matching apparatus, management apparatus, data repository, online professional network, online marketplace, etc.) may also be located on different nodes of a distributed system that implements the embodiments. For example, the present embodiments may be implemented using a cloud computing system that matches an RFP to a set of remote providers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A method, comprising:
identifying, by a computer system from a larger set of providers, a set of providers that meet a set of requirements in a request for proposal (RFP) from a consumer based on an overall compatibility between the set of requirements and the set of providers;
generating, by the computer system, a ranking of the set of providers based on the compatibility and a network distance between the consumer and the set of providers in a social network;
selecting, by the computer system, one or more providers from the ranking as matches for the RFP; and
transmitting the RFP to the one or more providers.

2. The method of claim 1, further comprising:
updating the ranking based on performance metrics for the set of providers.

3. The method of claim 2, wherein the performance metrics comprise at least one of:
an RFP receipt metric;
an RFP response metric; and
a proposal response metric.

4. The method of claim 1, further comprising:
tracking responses associated with the transmitted RFP; and
using the responses to update subsequent selection of the one or more providers as matches for other RFPs.

5. The method of claim 1, wherein identifying the set of providers that meet the set of requirements in the RFP based on the overall compatibility between the set of requirements and the set of providers comprises:
for each provider in the larger set of providers:
obtaining a set of compatibility scores, wherein each compatibility score in the set of compatibility scores represents an individual compatibility between a requirement in the set of requirements and the provider; and
aggregating the set of compatibility scores into an overall compatibility score representing the overall compatibility between the set of requirements and the provider; and
filtering the larger set of providers by the overall compatibility score to identify the set of providers.

6. The method of claim 5, wherein obtaining the set of compatibility scores comprises:
using a set of provider features for the provider to calculate a larger set of compatibility scores between the provider and all possible requirements in the RFP; and
obtaining the set of compatibility scores between the provider and the set of requirements from the larger set of compatibility scores.

7. The method of claim 6, wherein the set of provider features comprises:
a profile feature associated with a member profile of the provider in the social network; and
a social validation feature associated with the profile feature.

8. The method of claim 7, wherein the profile features comprise at least one of:
a service;
a skill;
a headline;
a summary;
a position; and
a title.

9. The method of claim 6, wherein the set of provider features comprises:
a geographic feature associated with a location of the provider; and
an activity feature representing historical activity of the provider with previous RFPs.

10. The method of claim 1, wherein generating the ranking of the set of providers comprises:
improving a position of a provider in the ranking based on a network distance between the provider and the consumer.

11. The method of claim 1, wherein selecting one or more providers from the ranking as matches for the RFP comprises:
selecting a first provider as a match for the RFP based on a position of the first provider in the ranking; and
randomly selecting a second provider in the ranking as another match for the RFP.

12. The method of claim 1, wherein the set of requirements comprises at least one of:
a service;
a project type;
a location;
a skill;
a tool; and
a task.

13. A system, comprising:
one or more processors; and
memory storing instructions that, when executed by the one or more processors, cause the apparatus to:
identify a set of providers that meet a set of requirements in a request for proposal (RFP) from a consumer based on an overall compatibility between the set of requirements and the set of providers;
generate a ranking of the set of providers based on the compatibility and a network distance between the consumer and the set of providers in a social network;
select one or more providers from the ranking as matches for the RFP; and
transmit the RFP to the one or more providers.

14. The system of claim 13, wherein the memory further stores instructions that, when executed by the one or more processors, cause the apparatus to:
update the ranking based on performance metrics for the set of providers wherein the performance metrics comprise at least one of:
an RFP receipt metric;
an RFP response metric; and
a proposal response metric.

14. (canceled)

15. The system of claim 13, wherein the memory further stores instructions that, when executed by the one or more processors, cause the apparatus to:
track responses associated with the transmitted RFP; and
use the responses to update subsequent selection of the one or more providers as matches for other RFPs.

16. The system of claim 13, wherein identifying the set of providers that meet the set of requirements in the RFP based on the overall compatibility between the set of requirements and the set of providers comprises:
for each provider in the larger set of providers:
obtaining a set of compatibility scores, wherein each compatibility score in the set of compatibility scores represents an individual compatibility between a requirement in the set of requirements and the provider; and
aggregating the set of compatibility scores into an overall compatibility score representing the overall compatibility between the set of requirements and the provider; and
filtering the larger set of providers by the overall compatibility score to identify the set of providers.

17. The system of claim 16, wherein obtaining the set of compatibility scores comprises:
using a set of provider features for the provider to calculate a larger set of compatibility scores between the provider and all possible requirements in the RFP; and
obtaining the set of compatibility scores between the provider and the set of requirements from the larger set of compatibility scores.

18. The system of claim 13, wherein the set of provider features comprises at least one of:
a profile feature associated with a member profile of the provider in the social network;
a social validation feature associated with the profile feature;
a geographic feature associated with a location of the provider; and
an activity feature representing historical activity of the provider with previous RFPs.

19. A non-transitory computer-readable storage medium storing instructions that when executed by a computer cause the computer to perform a method, the method comprising:
identifying, from a larger set of providers, a set of providers that meet a set of requirements in a request for proposal (RFP) from a consumer based on an overall compatibility between the set of requirements and the set of providers;
generating a ranking of the set of providers based on the compatibility and a network distance between the consumer and the set of providers in a social network;
selecting one or more providers from the ranking as matches for the RFP; and
transmitting the RFP to the one or more providers.

20. The non-transitory computer-readable storage medium of claim 20, wherein identifying the set of providers that meet the set of requirements in the RFP based on the overall compatibility between the set of requirements and the set of providers comprises:
for each provider in the larger set of providers:
obtaining a set of compatibility scores, wherein each compatibility score in the set of compatibility scores represents an individual compatibility between a requirement in the set of requirements and the provider; and
aggregating the set of compatibility scores into an overall compatibility score representing the overall compatibility between the set of requirements and the provider; and
filtering the larger set of providers by the overall compatibility score to identify the set of providers.
